(19) United States
(12) Patent Application Publication
(10) Pub. No.: US 2007/0024557 A1
(43) Pub. Date: Feb. 1, 2007

(54) Video signal processor, display device, and method of driving the same

(75) Inventors: Nam-seok Rho, Gyeonggi-do (KR); Mun-pyo Hong, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/495,834

(22) Filed: Jul. 28, 2006

(30) Foreign Application Priority Data
Jul. 29, 2005 (KR) 2005-0069842

(51) Int. Cl. G09G 3/36

(52) U.S. Cl. 345/88

(57) ABSTRACT

A video signal processor, a display device, and a method of driving the same, that consumes relatively low power and requires relatively small storage capacity, are provided. In one embodiment, a video signal processor comprises an interface to receive an external video signal; a signal converter including an RGBW logic to convert the video signal into an RGBW video signal, a rendering logic to render the converted RGBW video signal; a buffer to store the RGBW video signal; and a system controller to control the buffer and to output the buffered RGBW video signal.

### CROSS-REFERENCE TO RELATED APPLICATIONS

This application claims the benefit of Korean Patent Application No. 2005-0069842, filed Jul. 29, 2005, in the Korean Intellectual Property Office, the disclosure of which is incorporated herein by reference.

### BACKGROUND OF THE INVENTION

1. Field of the Invention

The present invention relates to a video signal processor, a display device, and a method of driving the same, and more particularly, to a video signal processor capable of processing four color video signals, a display device capable of representing an image with four color pixels, and a method of driving the same.

2. Description of the Related Art

A display device includes a liquid crystal display panel having a thin film transistor (TFT) substrate formed with thin film transistors, and a color filter substrate formed with a color filter layer, in which a liquid crystal layer is interposed between the TFT substrate and the color filter substrate.

Generally in a display device, a color filter layer comprising three primary colors of red (R), green (G), and blue (B) is formed on the color filter substrate, and the amount of light passing through the color filter layer is adjusted to thereby represent a desired color. Recently, display technology has been developed to enhance brightness by considering white (W) in addition to R, G, and B. Accordingly, prior LCD panels have been driven by a method that employs three colors to obtain pixel voltages corresponding to four colors; a rendering method that represents one dot by distributing the brightness of a pixel to an adjacent pixel while individually driving the pixel and its adjacent pixel at the same time; etc.

Meanwhile, in an LCD used for a portable terminal or the like, video data is processed by a method that processes the data depending on a central processing unit (CPU) of the portable device, and/or a method that processes the data independently of the CPU.

In the former case, the video data is directly transmitted to the LCD panel by control of the CPU, and the LCD panel processes the video data depending on a command from the CPU, which is called a CPU interface or a command interface. To use the CPU interface for processing the video data, a buffer memory is needed to store the video data before transmitting the data to the LCD panel.

In the latter case, the video data is transmitted to the LCD panel through an image processor controlled by the CPU, and the LCD panel processes the video data transmitted from the image processor according to the commands from the CPU, which is called a video or RGB interface.

Recently, a timing controller, logic for generating and rendering the pixel voltages corresponding to four colors, and a source driver have been integrated into one chip and used in the LCD panel. For technical and economical reasons, it is not feasible to embed a frame buffer for the CPU interface in this integrated chip. Therefore, the CPU interface cannot implement a signal process for generating and rendering the pixel voltages corresponding to four colors.

Further, in the case where the CPU interface is used for transmitting the video data to the LCD panel, and when the signal process logic of generating or rendering the pixel voltages corresponding to four colors follows the frame buffer, this signal process is performed even though the video data is not changed, thereby disadvantageously consuming much power.

### SUMMARY

Accordingly, it is an aspect of the present invention to provide a video signal processor that consumes relatively low power and requires relatively small capacity of storage.

Another aspect of the present invention is to provide a display device including a video signal processor that consumes relatively low power and requires relatively small capacity of storage, and a method of driving the same.

Additional aspects and/or advantages of the invention will be set forth in part in the description which follows and, in part, will be obvious from the description, or may be learned by practice of the invention.

The foregoing and/or other aspects of the present invention are achieved by providing a display device comprising a display panel; an interface to receive an external video signal; a signal converter including an RGBW logic to convert the video signal into an RGBW video signal, a rendering logic to render the converted RGBW video signal; a buffer to store the RGBW video signal; and a system controller for controlling the buffer to buffer the RGBW video signal outputted from the signal converter, and to transmit the buffered RGBW video signal to the display panel.

The foregoing and/or other aspects of the present invention are achieved by providing a video signal processor comprising an interface to receive an external video signal; a signal converter comprising an RGBW logic to convert the video signal into an RGBW video signal, and a rendering logic to render the converted RGBW video signal; a buffer to store the RGBW video signal; and a system controller for controlling the buffer to buffer the RGBW video signal outputted from the signal converter, and to output the buffered RGBW video signal.

The foregoing and/or other aspects of the present invention are achieved by providing a display device comprising a display panel; a first interface and a second interface; a system controller to input an external video signal to either of the first interface or the second interface according to resolution of the video signal; a signal converter comprising a rendering logic to selectively render the video signal received from either of the first interface or the second interface according to the resolution of the video signal; a buffer to store the video signal that is not rendered, and output the video signal on the basis of the control signal output from the system controller; and a driving circuit to apply the video signal output from either of the signal converter or the buffer to the display panel.

The foregoing and/or other aspects of the present invention are achieved by providing a display device comprising a display panel; a system controller; a first interface to receive a video signal applied to the display panel on the basis of a control signal of the system controller; a second interface to receive a video signal processed by an external video signal processor; a signal converter comprising an RGBW logic to convert the video signal received from either of the first interface or the second interface into an RGBW video signal, and a rendering logic to selectively render the RGBW video signal according to the resolution of the video signal; a buffer to store the video signal received through the first interface and output from the signal converter, and output the video signal on the basis of the control signal outputted from the system controller; and a driving circuit to apply the video signal output from either of the signal converter or the buffer to the display panel.

The foregoing and/or other aspects of the present invention are achieved by providing a video signal processor comprising a system controller; a first interface to receive a video signal applied to the display panel on the basis of a control signal of the system controller; a second interface to receive a video signal processed by an external video signal processor; a signal converter comprising RGBW logic to convert the video signal received from either of the first interface or the second interface into an RGBW video signal, and rendering logic to selectively render the RGBW video signal according to the resolution of the video signal; and a buffer to store the video signal received through the first interface and output from the signal converter, and output the video signal on the basis of the control signal output from the system controller.

The foregoing and/or other aspects of the present invention are achieved by providing a method of driving an display device, comprising a receiving an external RGB video signal; a converting the RGB video signal into an RGBW video signal; a rendering the RGBW video signal according to resolution of the video signal; a buffering the RGBW video signal; and an outputting the buffered RGBW video signal to an display panel on the basis of an external control signal.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is a layout diagram of a display device according to a first embodiment of the present invention;

FIG. 2 is a control block diagram of a video signal processor according to the first embodiment of the present invention;

FIG. 3 is a control block diagram of RGBW logic according to the first embodiment of the present invention;

FIG. 4 is a control block diagram of a video signal processor according to a second embodiment of the present invention;

FIG. 5 is a control block diagram of a video signal processor according to a third embodiment of the present invention; and

FIG. 6 is a control block diagram of a video signal processor according to a fourth embodiment of the present invention.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION

Reference will now be made in detail to the embodiments of the present invention, examples of which are illustrated in the accompanying drawings, wherein like reference numerals refer to like elements throughout. The embodiments are described below so as to explain the present invention by referring to the figures.

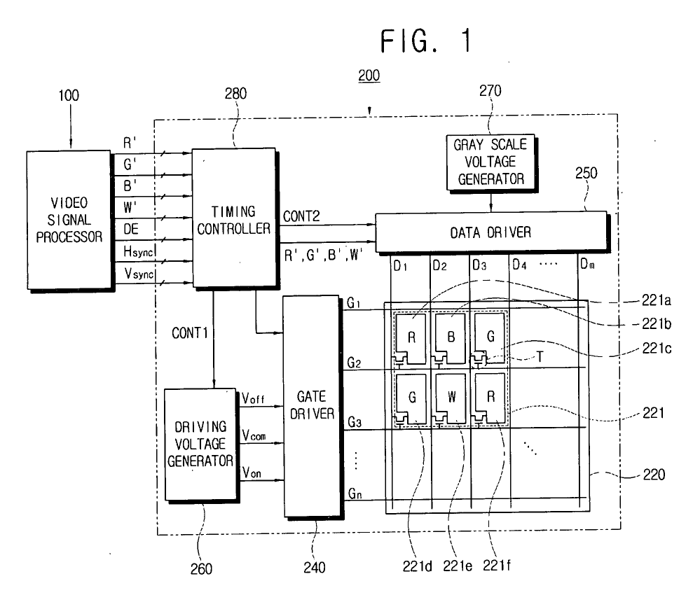

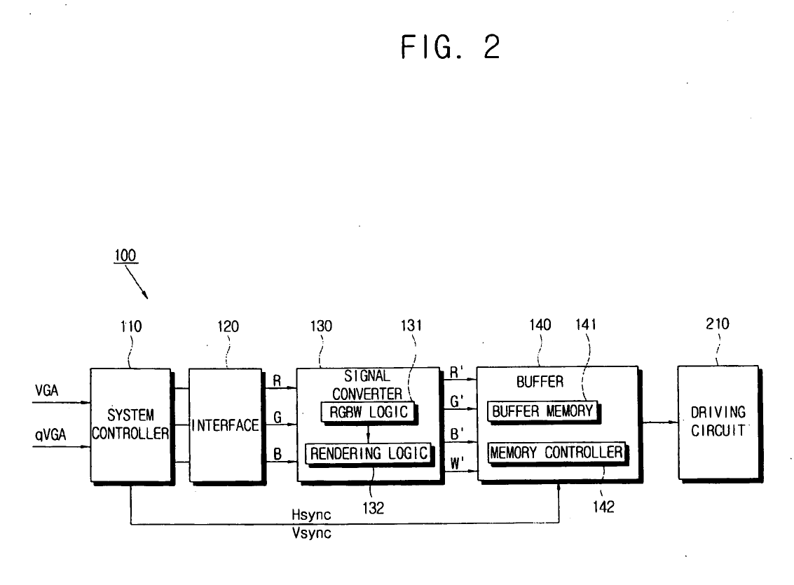

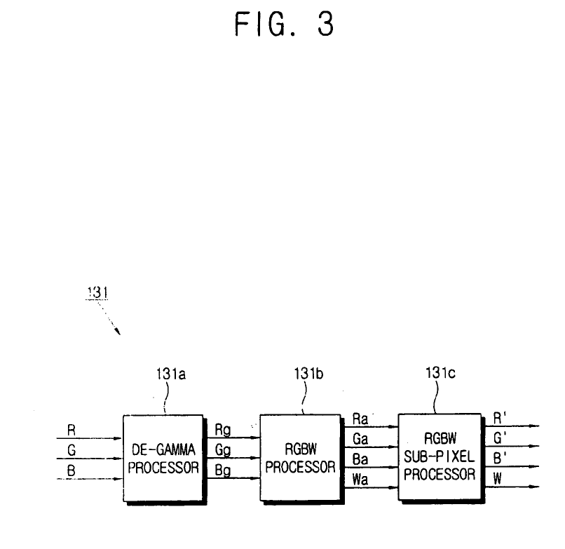

A first embodiment of the present invention will be described with reference to FIGS. 1 through 3. FIG. 1 is a layout diagram of a display device according to a first embodiment of the present invention, FIG. 2 is a control block diagram of a video signal processor according to the first embodiment of the present invention, and FIG. 3 is a control block diagram of RGBW logic according to the first embodiment of the present invention. According to the embodiment of the present invention, the display apparatus comprises a liquid crystal display (LCD). An LCD apparatus may be applied to a mobile terminal, such as a cellular phone or a personal digital assistant (PDA), but is not limited thereto. Instead, the LCD apparatus according to an embodiment of the present invention may be applied to various systems.

As shown in FIGS. 1-3, the LCD apparatus includes a video signal processor 100 and an LCD module 200. The LCD module 200 includes an LCD panel 220 (FIG. 1) and a driving circuit 210 (FIG. 2) for driving the LCD panel 220. The driving circuit 210 includes a gate driver 240, a data driver 250, a driving voltage generator 260, a gray scale voltage generator 270, and a timing controller 280.

The LCD panel 220 includes a plurality of gate lines G1 through Gn; a plurality of data lines D1 through Dm; and a plurality of sub-pixels 221a through 221f connected to the plurality of gate lines G1 through Gn and the plurality of data lines D1 through Dm and arranged as a matrix.

The gate lines G1 through Gn are extended in parallel with each other in an approximately row or horizontal direction. The data lines D1 through Dm are extended in an approximately column or vertical direction and perpendicularly intersect the gate lines G1 through Gn. Further, a thin film transistor T is operably connected to each intersection between the gate line and the data line.

A gate metal layer including the gate line and a gate electrode (not shown) of the thin film transistor T can be achieved by a single layer or a multi layer. In one example, the gate metal layer includes a conductive film of silver series metal such as silver or silver alloy, and a conductive film of aluminum series metal such as aluminum or aluminum alloy, etc., which have relatively low resistivity. On the conductive film, there may be an additional film of chrome, titanium, tantalum, molybdenum, or alloys thereof, which are excellent in physical, chemical and electrical contact characteristics with regard to a transparent electrode material.

Further, the gate metal layer is covered with a gate insulating layer (not shown) containing silicon nitride (SiNx) or the like.

A data metal layer, which includes the data lines D1 through Dm intersecting the gate lines G1 through Gn, and a data electrode of the thin film transistor T, is insulated from the gate metal layer. Like the gate metal layer, the data metal layer may be achieved by a multilayer so as to complement the metal or the alloy and obtain a desired physical property. In the case where the data metal layer is a multilayer, the data line may include a triple layer of molybdenum (Mo), aluminum (Al), and molybdenum (Mo) in one example.

Each sub-pixel 221a through 221f includes a thin film transistor T used as a switching device and connected at a position where the gate lines G1 through Gn and the data lines D1 through Dm intersect, a liquid crystal capacitor (C1c, not shown) connected to the thin film transistor T, and a storage capacitor (Cst, not shown). Here, six sub-pixels 221a through 221f are grouped into one pixel 221, and the pixel 221 is repetitively arranged along a row direction and a column direction. Here, the storage capacitor Cst can be omitted as necessary.

A passivation layer is formed between physical pixel electrodes forming the data metal layer and the sub-pixels 221a through 221f, and the thin film transistor T and the sub-pixels 221a through 221f are electrically connected to each other via a contact hole (not shown) formed through the passivation layer.

Sub-pixels 221a through 221f may be different in color. For example, one group pixel 221 includes red sub-pixels 221a and 221f, green sub-pixels 221c and 221d, blue sub-pixel 221b, and white sub-pixel 221e. Six sub-pixels 221a through 221f forming the pixel 221 are arranged as a 2×3 matrix. Here, the blue sub-pixel 221b and the white sub-pixel 221e are arranged as a middle pixel, and the pair of red sub-pixels 221a and 221f and the pair of green sub-pixels 221c and 221d are alternately arranged, leaving the middle pixel therebetween.

It is noted that the pixel 221 is not limited to the foregoing colored sub-pixels and the foregoing arrangement. Instead of red, green, blue, and white (RGBW) sub-pixels, cyan, magenta, yellow, and white sub-pixels may be grouped into the pixel. Further, the pixel may include only the RGB sub-pixels except the W sub-pixel.

The gate driver 240 is called a scan driver in one example, and is connected to the gate lines G1 through Gn. The gate driver 240 applies a gate signal formed by the combination of a gate-on voltage Von and a gate-off voltage Voff from the driving voltage generator 260 to the gate lines G1 through Gn.

The data driver 250 is called a source driver in one example. The data driver 250 receives a gray scale voltage from the gray scale voltage generator 270 and selects the gray scale voltage by control of a timing controller 280, thereby applying a data voltage to the data lines D1 through Dm.

A plurality of gate driving integrated circuits or a plurality of data driving integrated circuits may be embedded on a tape carrier package (TCP, not shown), and the TCP may be mounted to the LCD panel 220. Alternatively, without using the TCP, the plurality of gate driving integrated circuits or the plurality of data driving integrated circuits may be directly embedded on a glass substrate, which is called a chip on glass (COG) type. Further, a circuit performing the same function as such integrated circuits may be directly embedded on the LCD panel 220.

The driving voltage generator 260 generates the gate-on voltage to turn on the thin film transistor T, the gate-off voltage to turn off the thin film transistor T, and a common voltage Vcom to be applied to a common electrode.

The gray scale voltage generator 270 generates a plurality of gray scale voltages to control the brightness of the LCD apparatus.

The timing controller 280 generates control signals to control operations of the gate driver 240, the data driver 250, the driving voltage generator 260, and the gray scale voltage generator 270, and supplies the control signals to the gate driver 240, the data driver 250, and the driving voltage generator 260.

The timing controller 280 receives RGB video signals and an input control signal to control the RGB video signals from an external graphic controller (e.g., video signal processor 100). For example, the timing controller 280 receives a vertical synchronizing signal Vsync, a horizontal synchronizing signal Hsync, a main clock MCLK, a data enable signal DE, etc. The timing controller 280 transmits a gate control signal CONT1 to the driving voltage generator 260 and the gate driver 240 on the basis of the input control signal, and transmits four-color video signals R′, G′, B′ and W′ processed by the video signal processor 100 and a data control signal CONT2 to the data driver 250.

The gate control signal CONT1 includes a vertical synchronization start signal STV for starting an output of a gate-on pulse (gate-on voltage period), a gate clock signal CPV for controlling output timing of the gate-on pulse, a gate-on enable signal OE for defining the width of the gate-on pulse, etc.

The data control signal CONT2 includes a horizontal synchronization start signal STH for starting an input of the video signals R′, G′, B′ and W′, and a load signal LOAD or TP for applying the corresponding data voltages to the data lines D1 through Dm, etc.

First, the gray scale voltage generator 270 supplies the gray scale voltage determined by a voltage selection control signal VSC to the data driver 250.

The gate driver 240 sequentially applies the gate-on voltages Von to the gate lines G1 through Gn according to the gate control signal CONT1 from the timing controller 280, thereby turning on the thin film transistors T connected to the gate lines G1 through Gn.

At the same time, the data driver 250 receives the video signals R′, G′, B′ and W′ corresponding to the sub-pixels 221a through 221f connected to the turned-on thin film transistors T according to the data control signal CONT2 from the timing controller 280, and selects the gray scale voltages corresponding to the video signals R′, G′, B′ and W′ among the gray scale voltages from the gray scale voltage generator 270, thereby converting the video signals R′, G′, B′ and W′ into the corresponding data voltages.

The data signals transmitted to the data lines D1 through Dm are applied to the corresponding sub-pixels 221a through 221f via the turned-on thin film transistors T. Thus, the gate-on voltages Von are sequentially applied to all the gate lines G1 through Gn during one frame, thereby transmitting the data signals to all sub-pixels 221a through 221f.

Below, an operation of processing the video signal through the video signal processor 100 will be described with reference to FIGS. 2 and 3.

The video signal processor 100 includes a system controller 110 to control the whole system, an interface 120 to receive the video signal, a signal converter 130 to process the video signal, and a buffer 140 to store the video signal, which is operably connected to the driving circuit 210 of the LCD module 200.

Here, the system comprises an electronic device with the LCD apparatus. For example, the system may include a mobile device such as a cellular phone, a PDA, etc. The system controller 110 performs a general control related to an operation of the system and a data process. In the case of the cellular phone, the system controller 110 performs a general control related to transmitting/receiving data and processing a video signal and an audio signal. Typically, the system controller 110 corresponds to a CPU of the system.

According to an embodiment of the present invention, the video signal is applied to the LCD panel 220 by direct control of the system controller 110. That is, according to an embodiment of the present invention, a CPU interface or a command interface is employed for processing the video signal, in which the video signal is directly applied to the LCD panel 220 by the control of the system, and the driving circuit 210 processes the video signal depending on a command transmitted from the system controller 110.

The interface 120 receives the video signal and various control signals from a source outside of the interface. The video signal may be received through the system controller 110. Alternatively, the video signal may be received through a separate terminal and inputted to the signal converter 130 according to the control signals from the system controller 110. In one example, the signals received through the interface 120 include R, G and B video signals, and various control signals to apply the video signal to the LCD panel 220. It is noted that the color of the received video signal is not limited to red, green and blue, and may include other colors such as cyan, magenta and yellow.

The video signal received through the interface 120 has a resolution of VGA (480×640) or qVGA (quarter VGA: 240×320). In the general cellular phone, the LCD panel 220 has a resolution of hVGA (half VGA: 240×640). Thus, in the LCD panel 220 of the cellular phone, the video signal having the qVGA resolution should be applied to two pixel lines of the LCD panel 220, and the video signal having the VGA resolution should be processed by the following signal process.

The signal converter 130 includes RGBW logic 131 to convert the RGB video signal into the RGBW video signal, and rendering logic 132 to render the converted RGBW video signal.

The RGBW logic 131 may employ a method that extracts a white component from three-color and binary number RGB video signals, and processes the extracted white component into four-color RGBW video signals through a half-tone processor; a method that subtracts a pixel value from increasing values of three-color RGB video signals, and uses one difference value as an input value of the white component and the other increasing values as an output signal for the RGB video signal; etc.

In one embodiment, the RGBW logic 131 may not generate one four-color RGBW video signal but a plurality of RGBW video signals. In this case, the RGBW logic 131 outputs an optimized four-color RGBW video signal according to the characteristics of the LCD apparatus among the plurality of RGBW video signals, so that the performance of the LCD apparatus can be enhanced through various gray scale representation methods.

FIG. 3 is a control block diagram of the RGBW logic according to the first embodiment of the present invention. The RGBW logic is not limited thereto, and may vary. As shown therein, the RGBW logic 131 includes a de-gamma processor 131a, an RGBW processor 131b, and an RGBW sub-pixel processor 131c.

The de-gamma processor 131a removes a gamma correction signal (1/2.2 in the case of national television system committee (NTSC)) from the external three-color video signal according to channels.

The RGBW processor 131b receives the three-color channel video signal of which the gamma correction signal is removed by the de-gamma processor 131a, and adds the fourth color to the three-color channel video signal, thereby supplying it to the RGBW sub-pixel processor 131c. At this point in time, the three colors of RGB may have been changed somewhat.

The RGBW sub-pixel processor 131c calculates a brightness value corresponding to the sub-pixel with regard to the RGBW four-channel signal; thereby finally outputting the RGBW video signal.

In the LCD panel 220, the pixel having a matrix shape includes four-color sub-pixels, and the four colors are red, green, blue and white, so that the RGB video signal input to the signal converter 130 is processed by the RGBW logic 131 regardless of the resolution. For example, the video signal having the qVGA resolution is inputted to the buffer 130 via the RGBW logic 131, and the video signal having the VGA resolution is inputted to the buffer 140 after being rendered by the rendering logic 132. According to an embodiment of the present invention, the LCD apparatus includes a W sub-pixel in addition to the RGB sub-pixels for color representation, thereby enhancing the reflectivity by 30% due to the W sub-pixel to display a more vivid image.

The rendering logic 132 selectively renders the RGBW video signal according to the resolutions of the input video signal.

Rendering is the technology that the RGB pixels together with their adjacent pixels are individually driven while displaying an image as a dot to thereby disperse the brightness of the RGB pixels toward the adjacent pixels so that the image is displayed in more detail with an oblique or curved line and its resolution is adjusted. In this embodiment, the thin film transistor connected to one gate line and one data line is provided as a unit pixel for representing color, and a group of pixels capable of representing an image is called the dot. According to an embodiment of the present invention, the dot is formed over two pixel lines but is not limited thereto. Alternatively, the dot may be formed over three or more lines.

The rendering logic 132 according to an embodiment of the present invention selectively renders the video signal according to resolution, and more particularly renders the video signal according to vertical resolution. The rendering logic 132 counts the data enable signals DE or the horizontal synchronizing signals Hsync, thereby determining the vertical resolution. Alternatively, the rendering logic 132 may receive a signal related to resolution from the system controller 110 or an external device.

In one example, the rendering logic 132 renders the RGBW video signal when the vertical resolution of the video signal is equal to or higher than a predetermined value, but does not render the RGBW video signal when the vertical resolution is less than the predetermined value.

According to an embodiment of the present invention, the number of pixel lines ranges from about 300 to about 700. In this embodiment, it will be assumed that the number of pixel lines is 640. Further, a reference value is set as 600 at which the rendering logic 132 performs the rendering operation.

When a qVGA video signal having a vertical resolution of 320 is inputted, the rendering logic 132 determines the vertical resolution of the video signal, and compares the determined resolution of 320 with a preset value of 600. Because the vertical resolution of the input video signal is smaller than the preset value, the rendering logic 132 does not render the video signal. Then, the video signal is stored in the buffer 140 and applied to the LCD panel 220 by the driving circuit 210. In this case, the timing controller 280 of the driving circuit 210 controls the RGBW video signal corresponding to one pixel line to be displayed in two pixel lines, so that the video signal having a vertical resolution of 320 can be displayed in the LCD panel having a vertical resolution of 640.

When the VGA video signal having a vertical resolution of 640 is inputted, the rendering logic 132 determines the vertical resolution of the video signal, and compares the determined resolution of 640 with a preset value of 600. Because the vertical resolution of the input video signal is larger than the preset value, the rendering logic 132 renders the video signal.

In result, the LCD panel 220 has a vertical resolution of 320 by a dot unit when the rendering logic 132 does not render the video signal, and has a vertical resolution of 640 by the dot unit when the rendering logic 132 renders the video signal.

The conventional RGB pixels are grouped into one dot, and a total of twelve pixels are needed to form four dots. In other words, twelve data voltages are used to display an image on four dots. According to the embodiment of the present invention, the pixel 221 includes a total of six sub-pixels 221a through 221f, which are physically identical to twelve conventional RGB pixels. Further, the LCD apparatus according to an embodiment of the present invention employs a total of six pixels to represent an image corresponding to four dots, and requires not twelve but six data voltages.

The rendering logic 132 sets a mask having a plurality of sub-regions with respect to each pixel, and calculates the data voltage of the video signal corresponding to each pixel on the basis of the brightness corresponding to the sub-region adjusted depending on the difference in the brightness between the pixels corresponding to the sub-region and the neighboring sub-region. Based on this calculation, six sub-pixels are used in displaying an image corresponding to a total of four dots on the LCD panel 220. Thus, the data having the rendered data voltage is reduced by half as compared with the input video signal.

As a result, the rendering operation reduces the horizontal resolution, which is directly related to the number of data voltages, in half. Further, even though the VGA video signal is inputted, the LCD panel 220 having the hVGA resolution can process the VGA video signal to be displayed thereon.

Thus, the resolution of the video signal is processed as follows. When the video signal having a qVGA resolution of 240×320 is inputted, the video signal corresponding to one pixel line is applied to two pixel lines while maintaining the qVGA resolution. When the video signal having a VGA resolution of 480×640 is inputted, the video signal is rendered and converted to have a hVGA resolution of 240×640, thereby being displayed on the LCD panel 220 having a hVGA resolution of 240×640.

The buffer 140 includes a buffer memory 141 to buffer the RGBW video signal outputted from the signal converter 130, and a memory controller 142 to output the buffered RGBW video signal according to the control signals from the system controller 110.

In the video signal processed through the signal converter 130, a frequency of when the signal is stored in the buffer 140 is generally different from a frequency of when the signal is transmitted from the buffer 140 to the LCD panel 220. The system controller 110 provides the buffer 140 with the data including the video signal through the interface 120 only when the video signal is changed or updated, but the buffer 140 successively provides the LCD panel 220 with the video signal. That is, when the system controller 110 provides the video signal with a first frequency, the buffer 140 provides the LCD panel 220 with the video signal with a second frequency higher than the first frequency.

If the signal converter 130 were to follow the buffer 140 and process the video signal, the signal converter 130 would process the video signal provided with the second frequency even though the video signal had not been changed or updated. However, this structure is not suitable for the cellular phone in need of reducing power consumption. Thus, according to an embodiment of the present invention, the signal converter 130 precedes the buffer 140 and processes the video signal inputted with the first frequency.

The memory controller 142 reads the RGBW video signal stored in the buffer memory 141 according to the control signal of the system controller 110, and provides the RGBW video signal with the second frequency to the LCD panel 220. Here, the system controller 110 may directly adjust the RGBW video signal to have the second frequency and supply the signal to the LCD panel 220, so that the memory controller 142 cannot be separately provided in the buffer 140.

Further, a clock generator may be provided to generate a main clock signal for operating the buffer 140, and for providing the system controller 110 and the buffer 140 with the main clock signal.

The buffer memory 141 has storage capacity in consideration of the resolution of the video signal to be displayed in the LCD apparatus, and the operation of the signal converter 130. When the buffer memory 141 can store the video signal having the hVGA resolution, the video signal processor 100 can process both the video signal having the VGA and the video signal having the qVGA resolution because the video signal having the VGA resolution can be rendered to have the hVGA resolution. Thus, the rendering process according to the embodiment of the present invention converts the resolution of the video signal into a resolution to be stored in the buffer 140.

However, in the case where the buffer memory 141 can store the video signal having the qVGA resolution, when the video signal having the VGA resolution is inputted, the buffer memory 141 cannot buffer the video signal.

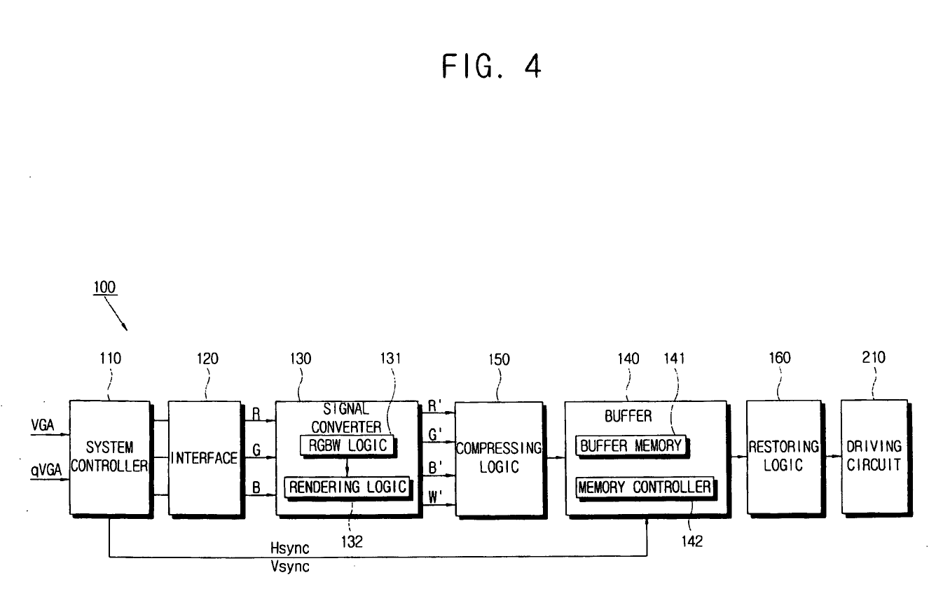

FIG. 4 is a control block diagram of a video signal processor according to a second embodiment of the present invention, in which an LCD module connected to a video signal processor 101 is substantially the same as that of the first embodiment, and thus repetitive descriptions thereof will be avoided.

As shown therein, the video signal processor 101 includes compressing logic 150 preceding the buffer 140, and restoring logic 160 following the buffer 140. Like the first embodiment, the buffer memory 141 has storage capacity to store the video signal having the qVGA resolution, the video signal having the VGA resolution is not displayed. Thus, according to the second embodiment of the present invention, the video signal compressed by the compressing logic 150 is stored and restored to have its original resolution by the restoring logic 160 before being applied to the LCD panel 220.

When the video signal having the resolution of VGA (480×640) is received and rendered, the data corresponding to a horizontal line is reduced in half, so that the video signal has the resolution of hVGA (240×640). Then, the video signal is compressed by the compressing logic 150 to have the resolution of qVGA (240×320) to be stored in the buffer memory 141, and then restored to have the resolution of hVGA (240×640) suitable for the LCD panel 220 before being applied to the driving circuit 210.

Here, the logic related to compressing and restoring the video signal can be performed by well-known operation logic, and further description will be omitted.

As the storage capacity of the buffer memory 141 becomes larger, the production cost increases. Therefore, industry is susceptible to the storage capacity of a memory such as the buffer memory 141. According to the second embodiment of the present invention, the storage capacity of the buffer memory 141 is minimized, and an image is displayed regardless of the resolution of the input video signal. Thus, various video signals are processed and a production cost is reduced.

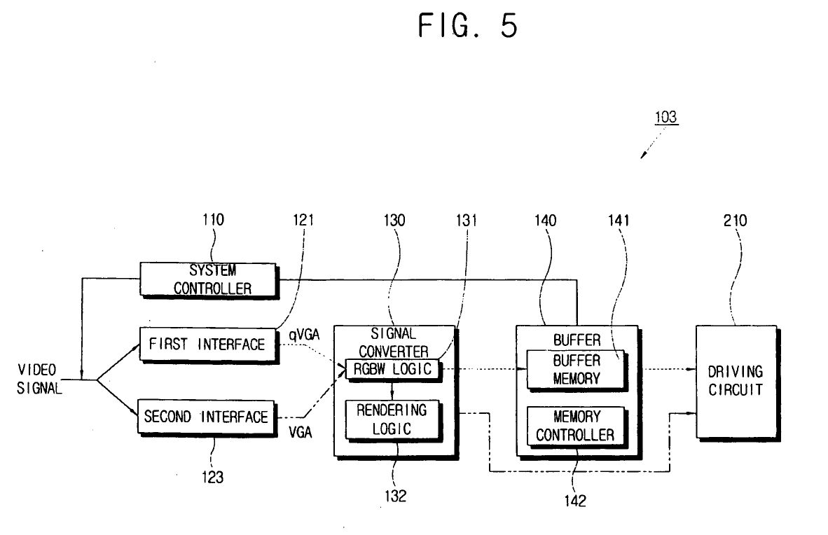

FIG. 5 is a control block diagram of a video signal processor according to a third embodiment of the present invention. As shown therein, a video signal processor 103 includes a first interface 121 and a second interface 123, and the video signal is either inputted to the first interface 121 or the second interface 123 according to the control of the system controller 110.

In one example, the system controller 110 controls the received video signal to be inputted to the first interface 121 when it has the qVGA resolution, and to the second interface 123 when it has the VGA resolution. That is, the first interface 121 comprises a CPU interface in which the video signal is processed by the direct control of the system controller 110 and applied to the LCD panel 220. Further, the second interface 123 comprises an RGB interface in which the video signal is processed and displayed independently of the system controller 110.

The video signal received through the first interface 121 is converted into the four-color video signal by the RGBW logic 131 of the signal converter 130 on the basis of the control signal from the system controller 110, and stored in the buffer 140. Then, the video signal stored in the buffer 140 is outputted, having a predetermined frequency to be displayed on the LCD panel 220. The video signal received through the first interface 121 has the qVGA resolution, so that the signal is not required to be rendered to be displayed on the LCD panel 220.

On the other hand, the video signal received through the second interface 123 is processed by the RGBW logic 131 and the rendering logic 132 of the signal converter 130, and directly transferred to the driving circuit 210 without being stored in the buffer 140. The video signal received from the second interface 123 is displayed on the LCD panel 220 in real time.

In the case where the buffer memory 141 of the buffer 140 corresponds to the qVGA resolution, the compressing logic 150 and the restoring logic 160 (described in the second embodiment) may be employed, thereby processing both the video signals, one signal having the qVGA resolution and the other signal having the VGA resolution.

A difference between the interfaces for processing the video signal is substantially identical with a difference in timing for applying the video signal.

Alternatively, the system controller 110 may select the first or second interface 121 or 123 according to not the resolution but the characteristics of the video signal, thereby inputting the video signal to the selected interface. Among the video signals transmitted to the portable terminal, in the case of a large amount of data such as a video signal corresponding to a moving picture, the driving circuit 210 may directly receive and display the RGB video signal. In the case of a relatively smaller amount of data, such as a video signal that corresponds to a still image and/or text information and does not require a middle color gray, the video signal may be stored in the buffer 140 and then transmitted to the LCD panel 220. Thus, the interfaces may be switched according to the characteristics of the video signal, thereby minimizing the power consumption.

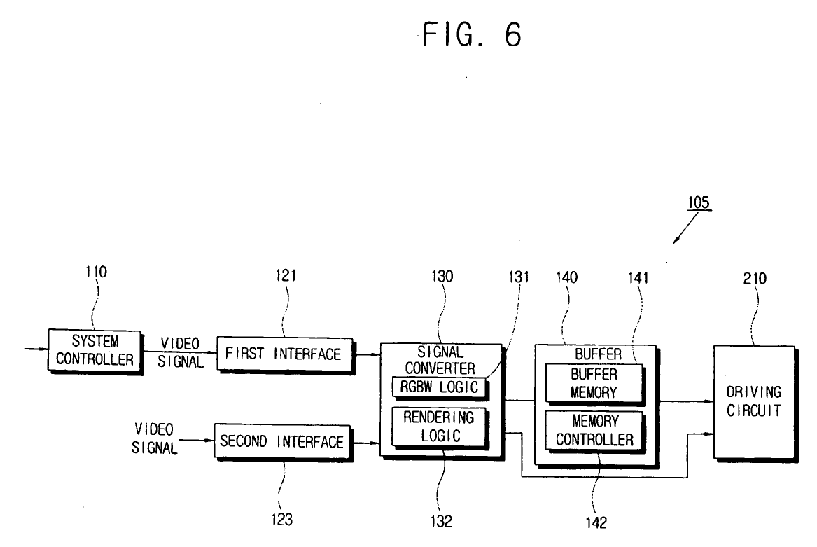

FIG. 6 is a control block diagram of a video signal processor 105 according to a fourth embodiment of the present invention. In the fourth embodiment as compared with the third embodiment, the first and second interfaces are not selected according to the resolution of the video signal.

As a method for displaying an image based on the video signal on the LCD panel 220 used for the portable terminal, the CPU interface or the RGB interface is related to the timing for displaying the video signal. Recently, an interface chip combining the CPU interface with the RGB interface has been developed and used. The interface method is determined by selection of a user, and one of them can be used according to a signal processing method selected by a user. According to an embodiment of the present invention, the rendering logic 132 for the rendering operation is embedded in such a single chip, so that the range of the video signal to be displayed in the LCD panel 220 can be widened, thereby giving a user opportunity for selecting the interface.

The first interface 121 receives the video signal input through the system controller 110, and the second interface 123 receives the video signal processed by an external video signal processor (not shown). Here, the video signal processor comprises a graphic controller or an image processor to process the video signal before inputting the video signal to the LCD panel 220.

In the case of the interface method that is controlled by the system controller 110, the video signal output from the signal converter 130 is stored in the buffer 140 and applied to the LCD panel 220 like the foregoing embodiments. Also, the aspects of the storage capacity of the buffer memory 141, the compressing logic 150, and the restoring logic 160 can be applied hereto.

Alternatively, the compressing logic 150 and the restoring logic 160 may be integrated into one chip together with other signal processing logic 131 and 132 of the signal converter 130.

In the foregoing embodiments, the resolution of the video signal suitable for the LCD apparatus is applied to the portable terminal by way of example, but not limited thereto. Further, the quantitative values such as the storage capacity of the buffer memory 141 may vary as long as it does not depart from the principles and spirit of the invention.

Further according to the present invention, the display device comprises an organic light emitting diode and/or an electro phoretic indication display.

As described above, the present invention provides a video signal processor, a display device and a method of driving the same, which consumes relatively low power and requires relatively small capacity of storage.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display device, comprising:
a display panel;
an interface to receive an external video signal;
a signal converter including an RGBW logic to convert the video signal into an RGBW video signal, and a rendering logic to render the converted RGBW video signal;
a buffer to store the RGBW video signal; and
a system controller for controlling the buffer to buffer the RGBW video signal outputted from the signal converter, and to transmit the buffered RGBW video signal to the display panel.

2. The display device according to claim 1, further comprising a driving circuit to drive the display panel, the driving circuit comprising:
a gate driver to apply a gate signal to the display panel;
a data driver to apply the RGBW video signal to the display panel; and
a timing controller to output a control signal for controlling the gate driver and the data driver.

3. The display device according to claim 1, wherein the rendering logic renders the video signal when the video signal has a vertical resolution equal to or higher than a predetermined value, and does not render the video signal when the video signal has a vertical resolution less than the predetermined value.

4. The display device according to claim 1, wherein the rendering logic converts the video signal to have a resolution to be stored in the buffer.

5. The display device according to claim 3, further comprising:
a pixel arranged as a matrix on the display panel; and
a driving circuit to drive the display panel,
wherein the driving circuit applies the RGBW video signal corresponding to one pixel row to two pixel rows when the video signal is not rendered.

6. The display device according to claim 1, wherein the video signal has a resolution selected from the group consisting of qVGA and VGA.

7. The display device according to claim 1, wherein the buffer comprises:
a buffer memory to buffer the RGBW video signal; and
a memory controller to read the RGBW video signal stored in the buffer memory and to output the RGBW video signal with a predetermined frequency on the basis of a control signal outputted from the system controller.

8. The display device according to claim 1, further comprising:
a compressing logic to compress the RGBW video signal rendered by the signal converter; and
a restoring logic to restore the compressed RGBW video signal.

9. The display device according to claim 1, wherein the display device comprises at least one of a liquid crystal display, an organic light emitting diode, and an electro phoretic indication display.

10. The display device according to claim 1, wherein the display panel comprises a liquid crystal display panel.

11. A video signal processor, comprising:
an interface to receive an external video signal;
a signal converter comprising an RGBW logic to convert the video signal into an RGBW video signal, and a rendering logic to render the converted RGBW video signal;
a buffer to store the RGBW video signal; and
a system controller for controlling the buffer to buffer the RGBW video signal outputted from the signal converter, and to output the buffered RGBW video signal.

12. The video signal processor according to claim 11, wherein the rendering logic renders the video signal when the video signal has a vertical resolution equal to or higher than a predetermined value, and does not render the video signal when the video signal has a vertical resolution less than the predetermined value.

13. The video signal processor according to claim 12, wherein the video signal has a resolution selected from the group consisting of qVGA and VGA.

14. The video signal processor according to claim 12, further comprising:
a compressing logic to compress the RGBW video signal rendered by the signal converter; and
a restoring logic to restore the compressed RGBW video signal.

15. A display device, comprising:
a display panel;
a first interface and a second interface;
a system controller to input an external video signal to one of the first interface and the second interface according to a resolution of the video signal;
a signal converter comprising a rendering logic to selectively render the video signal received from one of the first interface and the second interface;
a buffer to store the video signal that is not rendered, and to output the video signal on the basis of a control signal output from the system controller; and
a driving circuit to apply the video signal output from one of the signal converter and the buffer to the display panel.

16. The display device according to claim 15, wherein the video signal includes an RGB video signal, and the signal converter comprises an RGBW logic to convert the video signal into an RGBW video signal.

17. The display device according to claim 15, wherein the video signal has a resolution selected from the group consisting of qVGA and VGA.

18. The display device according to claim 15, wherein the rendering logic renders the video signal when the video signal has a vertical resolution equal to or higher than a predetermined value, and does not render the video signal when the video signal has a vertical resolution less than the predetermined value.

19. The display device according to claim 18, wherein the display panel comprises a pixel arranged as a matrix, and
the driving circuit applies the RGBW video signal corresponding to one pixel line to two pixel lines when the video signal is not rendered.

20. The display device according to claim 15, wherein the driving circuit comprises:
a gate driver to apply a gate signal to the display panel;
a data driver to apply the RGBW video signal to the display panel; and
a timing controller to output a control signal for controlling the gate driver and the data driver.

21. The display device according to claim 15, wherein the display panel comprises a pixel arranged as a matrix, the pixel comprising red, green, blue, and white sub-pixels grouped and formed as a dot, and
the sub-pixels grouped into a 2×3 matrix.

22. The display device according to claim 21, wherein the 2×3 matrix comprises the blue sub-pixel and the white sub-pixel arranged as a middle pixel, and a red sub-pixel and a green sub-pixel alternately arranged about the middle pixel.

23. The display device according to claim 21, wherein the dot corresponds to two pixel rows.

24. A display device, comprising:
a display panel;
a system controller;
a first interface to receive a video signal applied to the display panel on the basis of a control signal of the system controller;
a second interface to receive a video signal processed by an external video signal processor;
a signal converter comprising an RGBW logic to convert the video signal received from one of the first interface and the second interface into an RGBW video signal, and a rendering logic to selectively render the RGBW video signal according to a resolution of the video signal;
a buffer to store the video signal received through the first interface and output from the signal converter, and to output the video signal on the basis of the control signal output from the system controller; and
a driving circuit to apply the video signal output from one of the signal converter and the buffer to the display panel.

25. The display device according to claim 24, wherein the rendering logic renders the video signal when the video signal has a vertical resolution equal to or higher than a predetermined value, and does not render the video signal when the video signal has a vertical resolution less than the predetermined value.

26. The display device according to claim 24, wherein the video signal has a resolution selected from the group consisting of qVGA and VGA.

27. The display device according to claim 24, wherein the driving circuit applies the video signal corresponding to one pixel row to two pixel rows when the video signal is not rendered.

28. The display device according to claim 24, wherein the driving circuit comprises:
a gate driver to apply a gate signal to the display panel;
a data driver to apply the RGBW video signal to the display panel; and
a timing controller to output a control signal for controlling the gate driver and the data driver.

29. The display device according to claim 24, wherein the display panel comprises a pixel arranged as a matrix,
the pixel comprising red, green, blue, and white sub-pixels grouped and formed as a dot, and
the sub-pixels grouped into a 2×3 matrix.

30. The display device according to claim 29, wherein the sub-pixels comprise the blue sub-pixel and the white sub-pixel arranged as a middle pixel, and a pair of red sub-pixels and a pair of green sub-pixels alternately arranged, with the middle pixel therebetween.

31. The display device according to claim 29, wherein the dot corresponds to two pixel rows.

32. The display device according to claim 24, further comprising:
a compressing logic to compress the RGBW video signal rendered by the signal converter; and
a restoring logic to restore the compressed RGBW video signal.

33. A video signal processor, comprising:
a system controller;
a first interface to receive a video signal applied to the display panel on the basis of a control signal of the system controller;
a second interface to receive a video signal processed by an external video signal processor;
a signal converter comprising RGBW logic to convert the video signal received from one of the first interface and the second interface into an RGBW video signal, and rendering logic to selectively render the RGBW video signal according to a resolution of the video signal; and
a buffer to store the video signal received through the first interface and output from the signal converter, and to output the video signal on the basis of the control signal output from the system controller.

34. A method of driving a display device, the method comprising:
receiving an external RGB video signal;
converting the RGB video signal into an RGBW video signal;
rendering the RGBW video signal according to a resolution of the video signal;
buffering the RGBW video signal; and
outputting the buffered RGBW video signal to a display panel on the basis of an external control signal.

35. The method according to claim 34, wherein the rendering the RGBW video signal comprises rendering the video signal when the video signal has a vertical resolution equal to or higher than a predetermined value, and preventing the video signal from being rendered when the video signal has a vertical resolution less than the predetermined value.

36. The method according to claim 34, wherein the display panel comprises a pixel arranged as a matrix, and
wherein the outputting the RGBW video signal to the display panel comprises applying the RGBW video signal corresponding to one pixel row to two pixel rows when the video signal is not rendered.

37. The method according to claim 34, further comprising:
compressing the RGBW video signal between the rendering the RGBW video signal and the buffering the RGBW video signal; and
restoring the compressed RGBW video signal between the buffering the RGBW video signal and the applying the RGBW video signal to the display panel.
